(19) United States
(12) Patent Application Publication
(10) Pub. No.: US 2007/0089804 A1
(43) Pub. Date: Apr. 26, 2007

(54) Lathe apparatus

(76) Inventor: Peter Vincent, Upper Jay, NY (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/580,702

(22) Filed: Oct. 13, 2006

Related U.S. Application Data
(60) Provisional application No. 60/730,668, filed on Oct. 26, 2005.
(60) Provisional application No. 60/817,865, filed on Jun. 30, 2006.

(51) Int. Cl. B27C 5/00

(52) U.S. Cl. 142/7

(57) ABSTRACT

A copying lathe apparatus includes an elongate support rail, and a rotatable elongate drive screw positioned parallel to the support rail. A carriage assembly can be included and have a carriage member that is slidably mounted along and pivotably mounted about the support rail. The carriage member can have a follower for contacting a pattern, and a cutting tool mount for supporting a cutting tool capable of cutting a work piece. The follower and cutting tool mount can each extend radially outward relative to the support rail. The follower is capable of contacting the pattern, and pivoting while the carriage member slides on the support rail and cause corresponding pivoting movement of the carriage member and cutting tool mount about the support rail so that the cutting tool is capable of cutting the work piece in a manner corresponding to the pattern. A drive member can be mounted to and driven by the drive screw. Rotation of the drive screw can longitudinally move the drive member and carriage member along the support rail. The drive member can be connected to the carriage member by a joint that allows movement of the carriage member relative to the drive member to allow pivoting of the carriage member about the support rail.

### RELATED APPLICATION(S)

This application claims the benefit of U.S. Provisional Application No. 60/730,668, filed on Oct. 26, 2005 and U.S. Provisional Application No. 60/817,865, filed on Jun. 30, 2006. The entire teachings of the above application(s) are incorporated herein by reference.

### BACKGROUND

Some wood lathes include copying mechanisms which can trace a pattern, and at the same time, move a cutting tool in a manner that corresponds to the pattern so that a work piece can be cut as a copy of the pattern. Current copying lathes commonly have mechanisms that are complicated and expensive, or alternatively, have designs that do not always make accurate copies.

### SUMMARY

The present invention can provide a lathe apparatus that is capable of tracing a pattern and cutting a work piece as a copy of the pattern. The copying mechanism can be simple in design, while at the same time being capable of making accurate copies.

The present invention can provide a copying lathe apparatus including an elongate support rail. A rotatable elongate drive screw can be positioned parallel to the support rail. A carriage assembly can be included, and have a carriage member that is slidably mounted along and pivotably mounted about the support rail. The carriage member can have a follower for contacting a pattern, and a cutting tool mount for supporting a cutting tool capable of cutting a work piece. The follower and cutting tool mount can each extend radially outward relative to the support rail. The follower is capable of contacting the pattern and pivoting while the carriage member slides on the support rail and cause corresponding pivoting movement of the carriage member and cutting tool mount about the support rail so that the cutting tool is capable of cutting the work piece in a manner corresponding to the pattern. A drive member can be mounted to and driven by the drive screw. Rotation of the drive screw can longitudinally move the drive member and carriage member along the support rail. The drive member can be connected to the carriage member by a joint that allows movement of the carriage member relative to the drive member to allow pivoting of the carriage member about the support rail.

In particular embodiments, a cutting tool can be mounted to the cutting tool mount. The cutting tool can be a rotary saw having a rotary saw blade. The saw blade can be capable of being skewed at an angle relative to the work piece. The work piece can be supported by a work piece securement arrangement, and a work piece drive system can rotate the work piece in a direction opposite to rotation of the rotary saw blade. The drive member can have thread engaging portions which are spring loaded. The joint between the carriage member and the drive member can be formed by a drive protrusion on the carriage member extending into a gap on the drive member. The drive protrusion can have a curved periphery to allow movement within the gap when the carriage member pivots. The gap can be formed between outer surfaces of two spaced apart rollers. The support rail can have a circular periphery. The carriage member can include a set of rollers which are positioned to provide rolling along the support rail in the longitudinal direction, and pivoting about the support rail. The pattern can be held in a pattern holder. The support rail, drive screw and pattern holder can be mounted between end frame members. The lathe apparatus can be securable to an existing lathe.

In another embodiment, the present invention can provide a copying lathe attachment including end frame members for attachment to a lathe. An elongate support rail can extend between the end frame members. A rotatable elongate screw can be positioned parallel to the support rail and extend between the end frame members. A pattern holder for holding a pattern can extend between the end frame members. A carriage assembly can be included, and have a carriage member that is slidably mounted along and pivotably mounted about the support rail. The carriage member can have a follower for contacting the pattern, and a cutting tool mount for supporting a cutting tool capable of cutting a work piece. The follower and cutting tool mount can each extend radially outward relative to the support rail. The follower is capable of contacting the pattern and pivoting while the carriage member slides on the support rail, and cause corresponding pivoting movement of the carriage member and cutting tool mount about the support rail so that the cutting tool is capable of cutting the work piece in a manner corresponding to the pattern. A drive member can be mounted to and driven by the drive screw. Rotation of the drive screw can longitudinally move the drive member and carriage member along the support rail. The drive member can be connected to the carriage member by a joint that allows movement of the carriage member relative to the drive member to allow pivoting of the carriage member about the support rail.

In particular embodiments, a cutting tool can be mounted to the cutting tool mount and can be a rotary saw having a rotary saw blade. The drive member can have thread engaging portions which are spring loaded. The joint between the carriage member and the drive member can be formed by a drive protrusion on the carriage member extending into a gap on the drive member formed between outer surfaces of two spaced apart rollers. The drive protrusion can have a curved periphery to allow movement within the gap when the carriage member pivots. The support rail can have a circular periphery and the carriage member can include a set of rollers which are positioned to provide rolling along the support rail in the longitudinal direction and pivoting about the support rail.

The present invention can also provide a method of copying a pattern onto a work piece with a copying lathe apparatus. The method can include providing an elongate support rail. A rotatable elongate drive screw can be positioned parallel to the support rail. A carriage member of a carriage assembly can be slidably and pivotably mounted about the support rail. The carriage member can have a follower for contacting the pattern and a cutting tool for cutting the work piece. The follower and cutting tool can each extend radially outward relative to the support rail. A drive member can be driven with the drive screw. Rotation of the drive screw can longitudinally move the drive member and carriage member along the support rail. The drive member can be connected to the carriage member by a joint that allows movement of the carriage member relative to drive member to allow pivoting of the carriage member about the support rail. The follower contacts the pattern and pivots while the carriage member slides on the support rail and causes corresponding pivoting movement of the carriage member and cutting tool about the support rail for cutting the work piece in a manner corresponding to the pattern.

In particular embodiments, a rotary saw having a rotary saw blade can be employed as the cutting tool. The rotary saw blade can be skewed at an angle relative to the work piece. The work piece can be supported with a work piece securement arrangement and can be rotated in a direction opposite to the rotation of the rotary saw with a work piece drive system. The drive member can have thread engaging portions which can be spring loaded. The joint between the carriage member and the drive member can be formed by extending a drive protrusion on the carriage member into a gap on the drive member. The drive protrusion can have a curved periphery to allow movement within the gap when the carriage member pivots. The gap can be formed between outer surfaces of spaced apart rollers. The support rail can have a circular periphery. A set of rollers on the carriage member can provide rolling along the support rail in a longitudinal direction and pivoting about the support rail. The pattern can be held with a pattern holder. The support rail, drive screw and pattern holder can be mounted between end frame members. The lathe apparatus can be secured to an existing lathe.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a perspective view of an embodiment a lathe apparatus in the present invention.

FIG. 2 is a perspective view showing an embodiment of the carriage assembly.

FIG. 3 is a front view of the carriage assembly.

FIG. 4 is a side view of the carriage assembly.

FIG. 5 is a perspective view of another embodiment of a lathe apparatus in the present invention.

FIG. 6 is a front view of the lathe apparatus of FIG. 5.

FIG. 7 is a perspective view of the lathe apparatus of FIG. 5 with the carriage assembly omitted.

FIG. 8 is a perspective view of the frame of the lathe apparatus of FIG. 5 and showing an embodiment of the drive system.

FIG. 9 is an exploded view of an embodiment of the carriage assembly.

FIGS. 10 and 11 are perspective views of an embodiment of the tail stock assembly.

FIGS. 12 and 13 are perspective views of yet another embodiment of a lathe apparatus in the present invention.

FIG. 14 is an exploded view depicting the assembly of end frame members to the bed of a lathe.

FIG. 15 is an exploded view of another embodiment of a carriage assembly.

### DETAILED DESCRIPTION

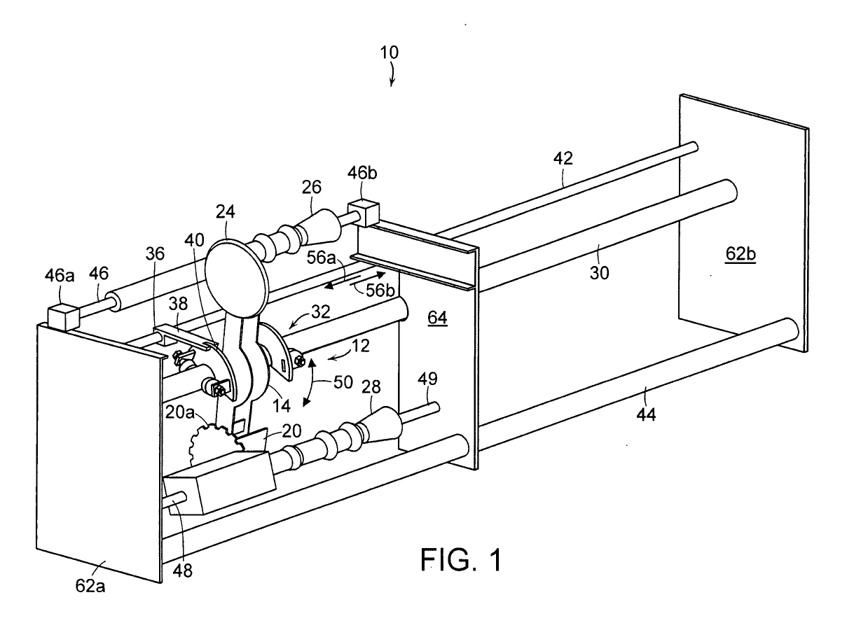

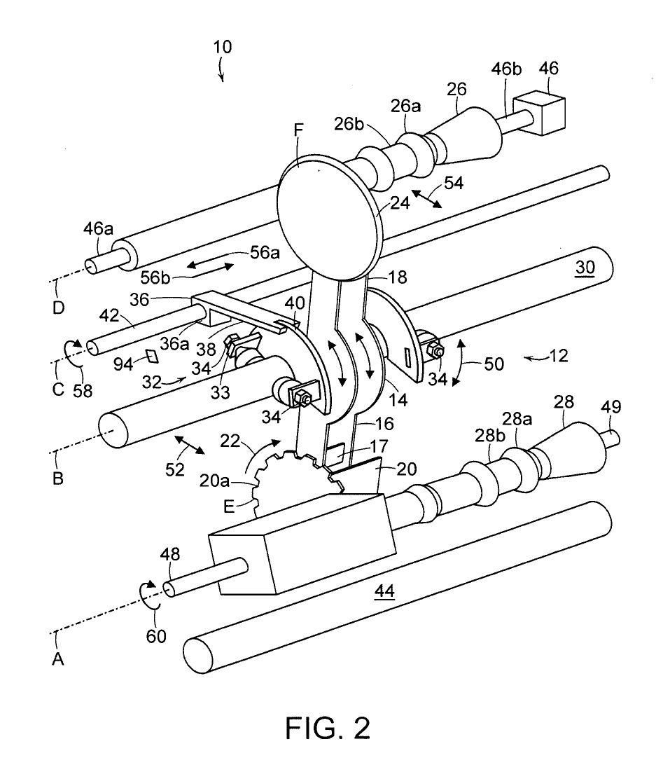

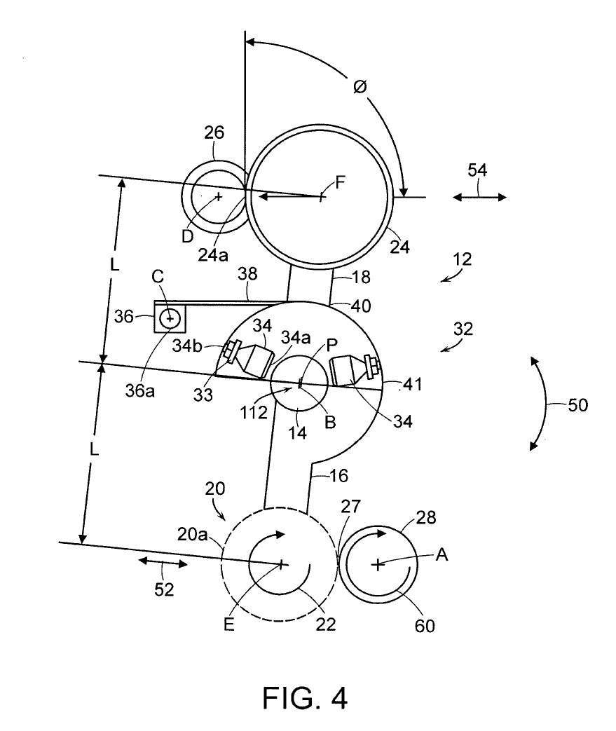

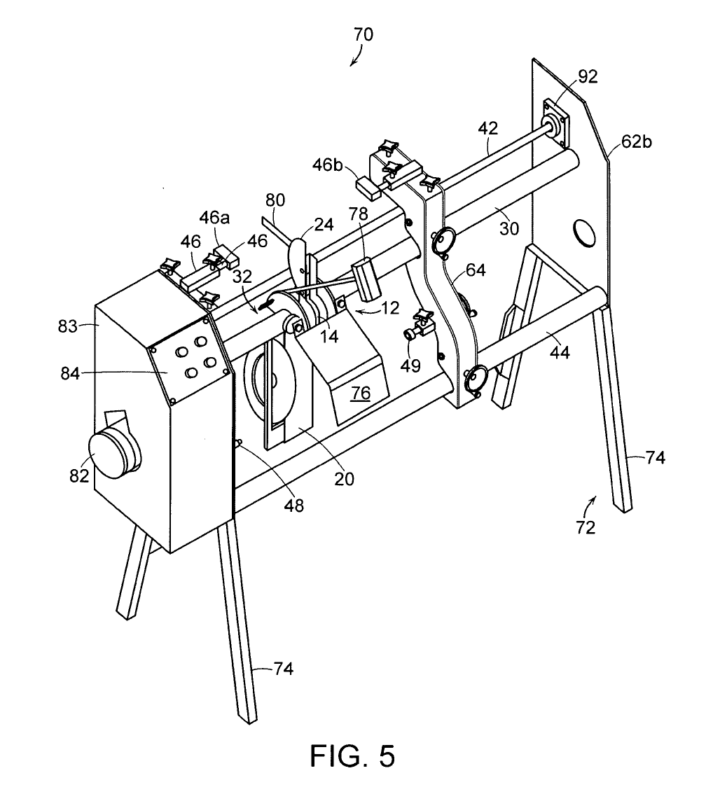

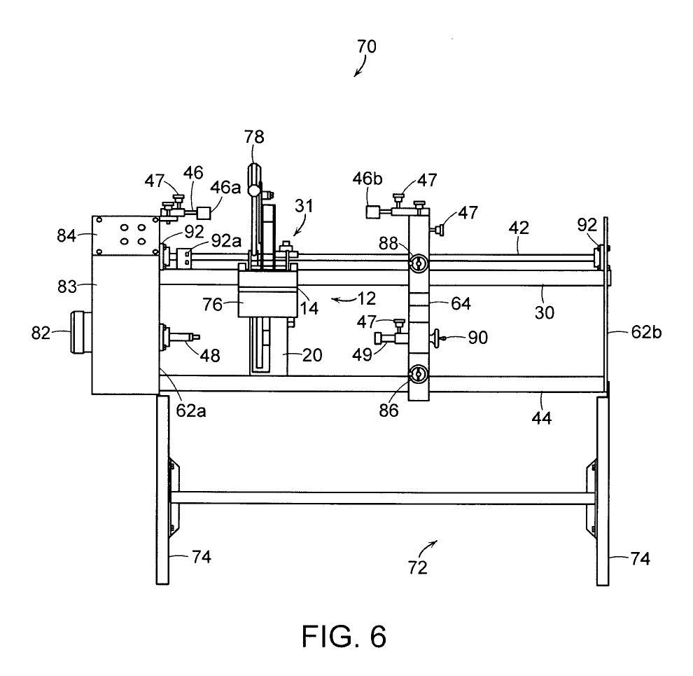

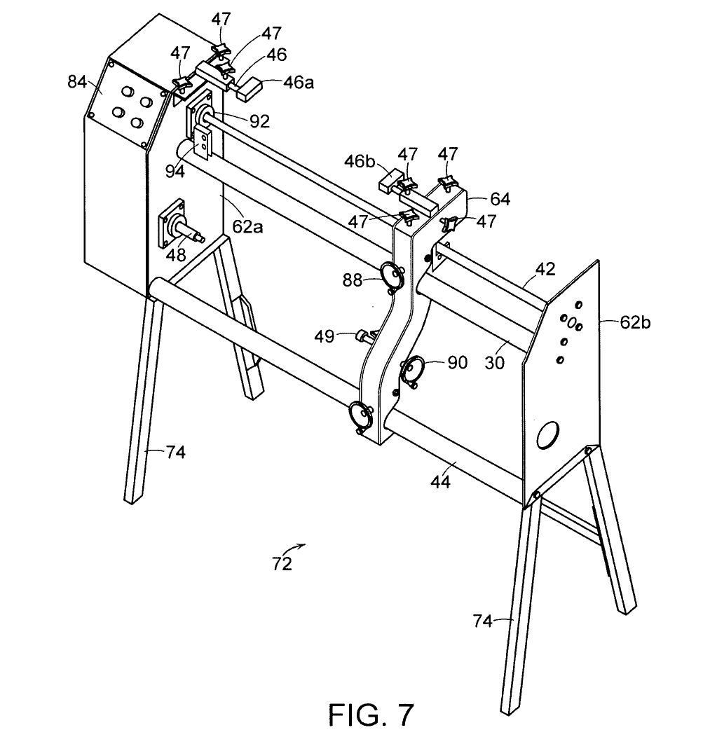

Referring to FIGS. 1-4, lathe apparatus 10 is an embodiment in the present invention which can include a carriage assembly 12 with a carriage 14 having a template or pattern follower 24 for tracing a template or pattern 26, and causing complimentary or corresponding movement of a cutting tool 20, for cutting a work piece 28, such as a piece of wood. The cutting tool 20 can be a rotary saw having a rotary saw blade 20a rotating about an axis E (FIGS. 2 and 4). The lathe apparatus 10 can include end frame members 62a and 62b, which are spaced apart and which support therebetween, a carriage support rail 30 along a longitudinal axis B, and a linear drive mechanism such as a rotatable carriage drive screw 42 along a longitudinal rotational axis C. A frame support 44 can also be mounted to and extend between the end frame members 62a and 62b to provide additional support and rigidity. The carriage support rail 30 and the frame support 44 can be rigidly fixed to the end frame members 62a and 62b. The carriage support rail 30 can have a circular periphery or cross section. A tail stock assembly 64 can be adjustably moveable between the end frame members 62a and 62b to adjust for different lengths of patterns 26 and work pieces 28, and can slide on and be locked into position to the carriage support rail 30 and the frame support 44. The work piece 28 can be supported and rotatably driven at one end about a rotational longitudinal axis A by a rotatable drive center 48. The drive center 48 can be part of and driven by a drive system such as in the embodiment depicted in FIGS. 5-11. The same or a different drive system can drive and rotate the carriage lead screw 42. The opposite end of the work piece 28 can be rotatably supported by a rotatable tail center 49 extending from the tail stock assembly 64. Rotation of the work piece 28 can be in the direction of arrow 60. The pattern 26 can be secured along a longitudinal axis D by a pattern holder 46. The pattern holder 46 can have a first securement portion 46a mounted to end frame member 62a for securing a first end of the pattern 26, and a second securement portion 46a mounted to the tail stock assembly 64 for securing a second end of the pattern A.

The carriage assembly 12 can include a carriage or carriage member 14 that is slidably and pivotably mounted along and about the carriage support rail 30 and longitudinal axis B, about a central opening 112 and pivot P, by a bearing arrangement 32. The carriage 14 can be drivably connected or coupled to the carriage lead screw 42 by a feed or drive member, dog or nut 36 for driving the carriage 14 longitudinally along the carriage support rail 30, for example, as shown by arrows 56a and 56b. The drive nut 36 can have a hole with thread engaging forms 36a, which can include female thread forms for engaging the male threads of the carriage lead screw 42. The drive nut 36 can have a linkage 38 that is connected to the carriage 14 by a joint 40. The joint 40 allows movement of the carriage 14 relative to the drive nut 36 and the carriage lead screw 42, thereby allowing pivoting of the carriage 14 about the carriage support rail 30 and longitudinal axis B. The joint 40 can allow pivoting of the carriage 14, with the carriage support rail 30 and the carriage lead screw 42 being in fixed positions parallel to each other. The joint 40 can be formed by opposed surfaces extending downwardly from the linkage 38 which moveably or slidably capture a curved flange 41 extending from the carriage hub 14a. The curved shape of the flange 41 has a configuration which can allow pivoting between the opposed surfaces. Travel of the carriage assembly 12 can be stopped at desired positions by adjusting the location of a stop or limit switch 94 (FIG. 2), which can be in electrical communication with the drive system for the carriage lead screw 42.

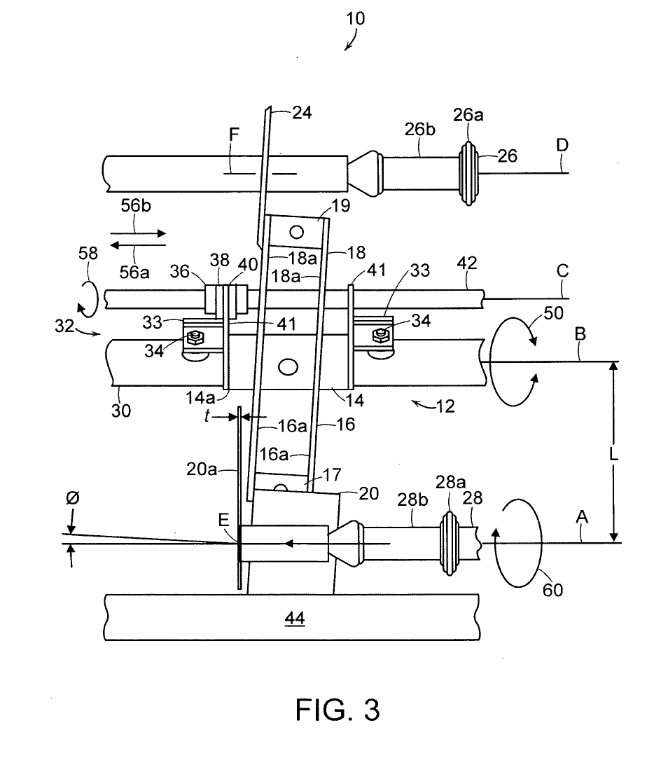

The pattern follower 24 can be formed of sheet material and extend from the carriage 14 from a follower arm 18. The pattern follower 24 can be mounted to the follower arm 18 on a follower mount 19 (FIG. 3). The pattern follower 24 can be configured to have physical features in common with the rotary saw blade 20a, such as thickness, shape, and contact radius, in order to provide similar contact characteristics as the saw blade 20a to increase accuracy in the copying process. The rotary saw 20 can extend from the carriage 14 from a cutting tool or saw arm 16 and can be mounted to the arm 16 on a cutting tool or saw mount 17. The rotary saw blade 20a of the rotary saw 20 can have a thickness t and can be positioned or centered along a rotatable axis E which can be spaced the same distance L from pivot P as the center F of pattern follower 24. This can provide pivotable balance for the carriage 14 and can allow copying of the contours of the pattern 26 onto the work piece 28 with a 1 to 1 ratio. The arms 16 and 18 can be in line with each other on opposite sides of carriage 14, and each can be formed by spaced arm members 16a and 18a (FIG. 3). Both arms 16 and 18 can pivot about the support rail 30 simultaneously. In other embodiments, the arms 16 and 18 do not have to be in alignment and can be angled relative to each other. The arms 16 and 18 can be skewed slightly (FIG. 3) to skew the rotary saw blade 20a by a slight angle θ (for example a few degrees) relative to the longitudinal axis A of the work piece 28 to aid in the cutting process. Alternatively, the rotary saw 20 can be mounted to the saw mount 17 in a manner that skews the rotary saw blade 20a.

The bearing arrangement 32 can be formed by four roller bearing assemblies 34 which can be positioned in downwardly angled pairs, for example, at about 30° from horizontal, on opposite sides of the upper surface of the carriage support rail 30 and on opposite longitudinal ends of the carriage 14. Other suitable angles can be used. The roller bearing assemblies 34 can have stems 34b (FIG. 4) that are secured by mounts 33 attached to the flanges 41, and can include spherical rollers 34a which reduce friction of the carriage 14 in both longitudinal sliding or rolling along support rail 30 in the direction of arrows 56a and 56b, as well as pivoting or rotating, sliding or rolling about the support rail 30 in the direction of arrow 50. The bearing assemblies 34 with the spherical rollers 34a are suitable for operating in an environment covered with saw dust and wood chips due to a limited number of point contacts with the carriage support rail 30 (for example, four points). In addition, the bearing arrangement 32 can allow the carriage 14 to be easily removed from the carriage support rail 30 by lifting the carriage 14 upwardly off the carriage support rail 30. Alternatively, the bearing arrangement 32 can be formed by other suitable methods such as one or more standard bushings, for example bronze bushings, or roller bushings.

In operation, the tail stock assembly 64 can be adjusted and locked in position according to the length of the pattern 26 to be copied or the length of the work piece 28. The pattern 26 can be secured in the pattern holder 46. The pattern 26 can be an actual turned piece of work to be duplicated, as shown in FIG. 1, and the securement portions 46a and 46b can hold the pattern 26 between centers. The pattern 26 can also be a flat template, in which case the securement portions 46a and 46b can include clamping devices. The work piece 28 can be mounted between the drive center 48 and the tail center 49. The limit switch 94 can be positioned to shut down travel of the carriage assembly 12 at the end of the pattern 26. In the embodiment shown, travel of the carriage assembly 12 during cutting is from right to left, but can be from left to right.

The carriage assembly 12 can positioned so that the pattern follower 24 is at the beginning of the pattern 26, for example, the right hand side. The work piece 28 can be rotated about longitudinal axis A, for example, in the direction of arrow 60. The rotary saw 20 can be started and the pattern follower 24 moved into contact with the pattern 26. The contact point 24a of pattern follower 24 can contact the surface of the pattern 26 at an angle φ (FIG. 4), for example, about 90° relative to the center F through the horizontal axis of the follower 24. The rotary saw blade 20a can be rotated, for example, in the direction of arrow 22, in which the surfaces of the rotary saw blade 20a and the work piece 28 that contact each other, at the contact point 27, are moving in opposite directions. Typically, the rotary saw blade 20a is rotated in a direction that directs saw dust and wood ships downwardly.

The carriage lead screw 42 can be rotated about longitudinal rotational axis C to drive the carriage assembly 12 in the direction of arrow 56a. As the carriage 14 slides longitudinally along the support rail 30 and longitudinal axis B on bearing arrangement 32, the pattern follower 24 contacts the contours on the side of the pattern 26 and laterally moves towards and away from the pattern 26 or longitudinal axis D in the direction of arrows 54 (FIGS. 2 and 4) as the pattern follower 24 contacts peaks 26a and valleys 26b on the side of the pattern 26. This pivots the carriage 14 about the support rail 30 and longitudinal axis B in the direction of arrows 50, thereby causing the rotary saw 20 and rotary saw blade 20a to move towards and away from the work piece 28 or longitudinal axis A, in the direction of arrows 52 to cut peaks 28a and valleys 28b in the work piece 28, in a manner corresponding to the pattern 26. The rotary saw blade 20a can be skewed to reduce the chance of binding in the work piece 28. The speed at which the carriage assembly 12 is moved in the longitudinal direction 56a can be adjusted to take into account wood hardness and the depth of cut. When the carriage assembly 12 reaches and trips the limit switch 94, the drive controlling the carriage lead screw 42 stops rotation of the lead screw 42, thereby stopping travel of the carriage assembly 12. The rotary saw 20 can then be turned off. If desired, the work piece 28 can be rotated by the drive center 48 and sanded. The finished work piece 28 can be removed and another work piece 28 can be secured in position, with the carriage assembly 12 being moved into the appropriate starting position.

In particular embodiments, the carriage assembly 12 can be balanced so that the pattern follower 24 lightly follows the pattern 26, thereby reducing wear on the pattern 26 as well as binding of the pattern follower 24 on the pattern 26. Positioning the pattern follower 24 to contact the pattern 26 on the lateral side of the pattern 26 can also contribute to reducing the pressure at which pattern follower 24 contacts the pattern 26. Positioning the rotary saw blade 20a to contact the work piece 28 on the lateral side of the work piece 28 can also contribute to the balance of the carriage assembly 12 and minimize the pressure of the pattern follower 24 on the pattern 26. Such lateral contact by the pattern follower 24 and the rotary saw blade 20a can be provided by positioning the pattern follower 24 vertically above the rotary saw blade 20a (FIG. 4). The axes A, B and D can be positioned relative to each other to achieve such positioning. The pattern 26 and longitudinal axis D can be positioned vertically above the carriage support rail 30 and longitudinal axis B, and laterally offset to one side. The work piece 28 and longitudinal axis A can be positioned vertically below the carriage support rail 30 and longitudinal axis B, and laterally offset to the opposite side.

The centers of the pattern follower 24 and rotary saw blade 20a, at E and F, can be in general or approximate horizontal or lateral alignment with the respective longitudinal axes D and A of the pattern 26 and the work piece 28. The pattern follower 24 can be positioned to be angled, for example at 45°, to allow smooth movement against the pattern 24. The pattern holder 46 can be adjusted for proper lateral and longitudinal alignment of the pattern 26, for example along longitudinal axis D and in parallel relationship with longitudinal axes A, B and C. The carriage assembly 12 can advance longitudinally along the support rail 30 about 1/32 of an inch for every revolution of the work piece 28. The carriage assembly 12 speed can be adjusted by a dial on a control panel (for example 84 in FIG. 5) to achieve a speed that can cut the work piece 28 while limiting stress on the work piece 28. The rotary saw 20 can be a hypoid gear drive saw and the rotary saw blade 20a can be rotated at about 1750 rpm or greater. The high speed of the rotary saw blade 20a can allow the work piece 28 to be rotated slowly while still cutting the work piece 28 quickly. Slow rotation of the work piece 28 can prevent the work piece 28 from falling apart. If desired, the carriage assembly 12 and rotary saw 20 can be moved or operated by hand to cut an original work piece 28 rather than make a copy. Although the rotary saw blade 20a can be slightly skewed, in general, the axis of rotation E is considered to be approximately parallel to the rotational axis A of the rotary work piece 28. In addition, the axes A, B, C and D are normally parallel to each other.

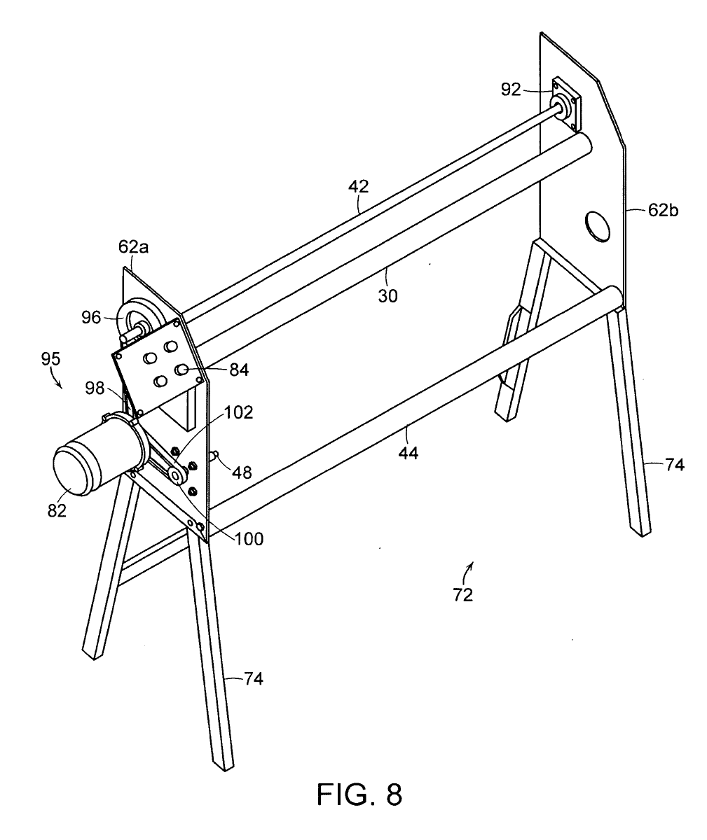

Referring to FIGS. 5-8 lathe apparatus 70 is an embodiment in the present invention in which the end frame members 62a and 62b can be supported on a frame assembly 72 having legs 74. End frame member 62a can be adjacent to or attached to a housing 83, which houses the drive system 95 (FIG. 8), and a control panel 84. The carriage lead screw 42 can be rotatably supported or fixed between the end frame members 62a and 62b by bearings 92. The tail stock assembly 64 and the pattern holder 46 can include adjustment knobs 47 for adjusting and tightening the position of the tail center 49, and the securement portions 46a and 46b of the pattern holder 46. Knobs 86 and 88 can lock the tail stock assembly 64 to the frame support 44 and support rail 30, respectively. Knob 90 can provide further longitudinal adjustment for tail center 49. The carriage assembly 12 can have a guard 76 for safety purposes. A counter balance weight 78 can extend from the carriage 14 for balancing the carriage assembly 12. A bar 80 can be attached to the pattern follower 24 to serve as a handle for manual movement, manipulation or operation of the carriage assembly 12.

Referring to FIG. 8, the drive system 95 can be driven by a motor 82 and controlled by the controls on control panel 84. The control panel 84 can include on-off switches and dials for controlling speeds. The drive center 48 can be driven by a belt 102 and pulley 100 connected to the motor 82. The carriage lead screw 42 can be driven by a belt 98 and pulley 96, which can be connected to the same motor 82, if desired, or a different motor. In some embodiments, gear transmissions or direct drive motors can be employed.

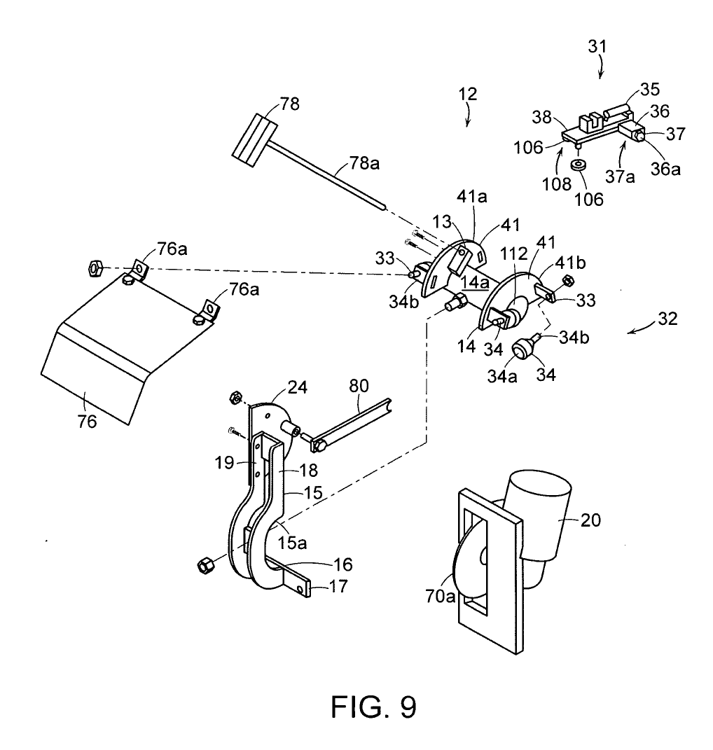

Referring to FIG. 9, the carriage assembly 12 can have arms 16 and 18 formed by a fabricated member 15 which is secured to the hub 14a. Member 15 can have a curved contour 15a for mating with the hub 14a. The guard 76 can be mounted to mounts 33 with hinges 76a. The carriage 14 can be balanced as desired by a counterweight or counterbalance 78 having a stem 78a that is secured to the carriage 14 at or near the hub 14a, for example, to a mount 13 on flange 41a. The desired balance can be selected by adjusting the weight of counterweight 78, the length of the stem 78a, as well as the angle or position from which the stem 78a is secured to the carriage 14. The drive nut 36 can be part of a feed or drive member, dog or nut assembly 31. The linkage 38 extending from the drive nut 36 can have a pair of space apart rollers 106 extending downwardly from the linkage 38. The space or gap 108 between the surfaces of the rollers 106 allows rolling trapped engagement with the mating flange 41b, thereby forming joint 40 with the carriage 14. Joint 40 is engageable and disengageable merely by lowering or lifting the linkage 38 and rollers 106 onto or off from the flange 41b. The drive nut 36 can be a partial or split nut 37 having lateral opening 37a that can have thread engaging forms 36a that are spring loaded towards each other by a spring 35 on the linkage 38. As a result, the drive nut 36 and thread engaging forms 36a can be engaged or disengaged with the carriage lead screw 42 through the lateral opening 37a. Therefore, the drive nut assembly 31 can be easily attached or removed from the carriage lead screw 42 and the carriage 14, so that if desired, the carriage 14 can be manually operated, or moved into a desired position.

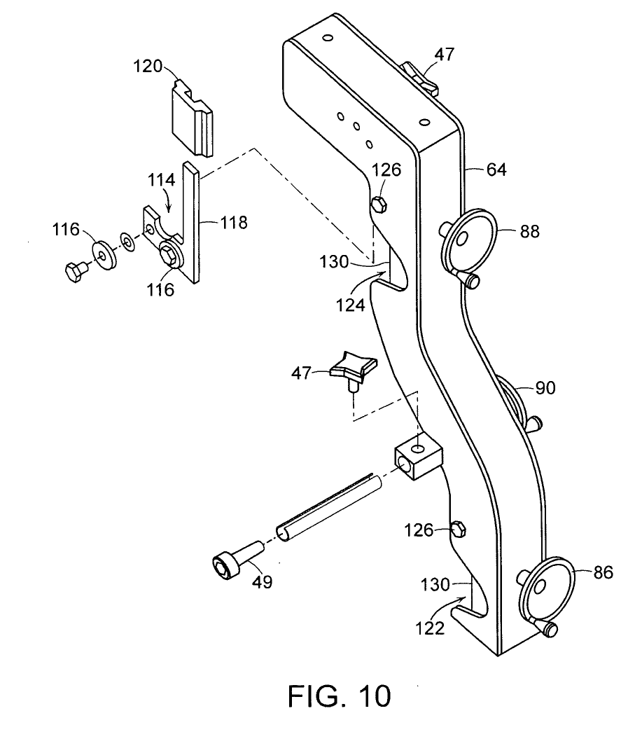

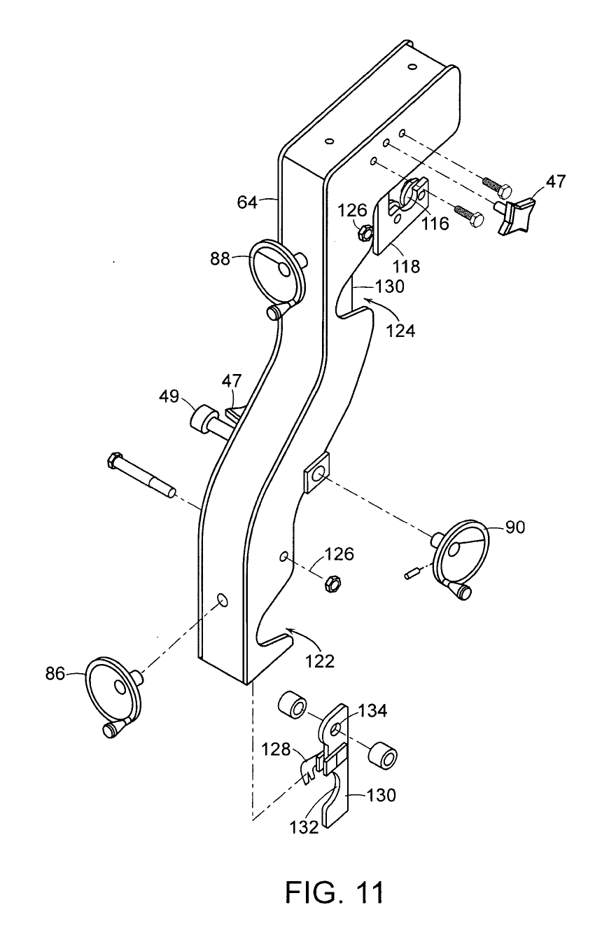

Referring to FIGS. 10 and 11, the tail stock assembly 64 an include slots or notches 122 and 124 to allow passage of the frame support 44 and the support rail 30. Locking members 130 can be positioned within notches 122 and 124. Each locking member 130 can have a pivoting joint 134 that is pivotable about an axis 126 on the tail stock assembly 64. Knobs 86 and 88 can each have a threaded stem which engages a threaded hole 128 in the locking member 130 for pivoting locking member 130 and locking the frame support 44 and support rail 30 between the notches 122 and 124 and the notch 132 of the locking members 130. The tail stock assembly 64 can also include a lead screw support 118 having a pair of rollers 116 which engage the carriage lead screw 42 on the upper surfaces 114. The lead screw support 118 can be attached to a bracket 120 and the height of the support 118 can be adjusted. The lead screw support 118 can be locked in place by a knob 47.

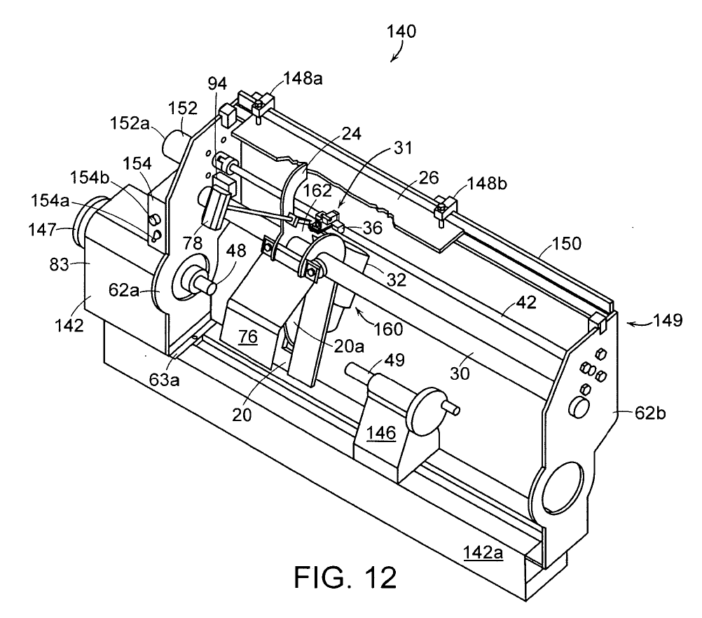

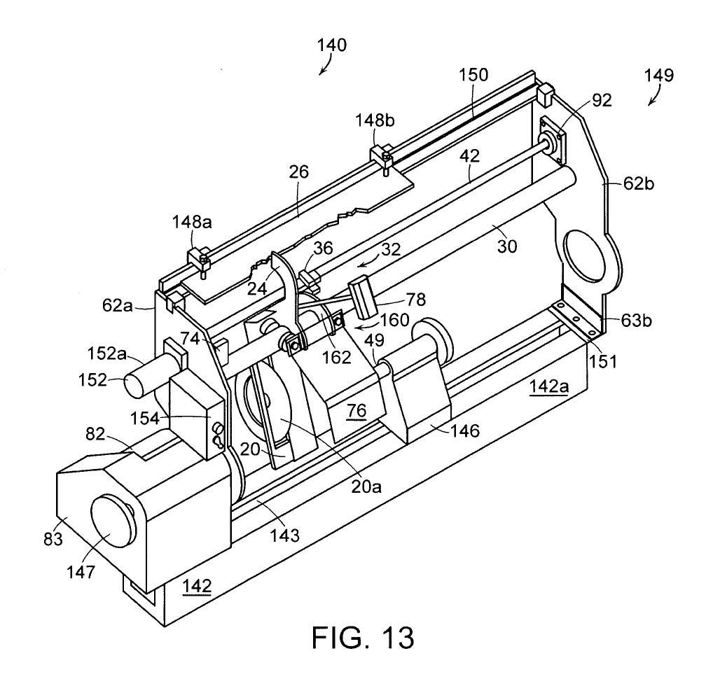

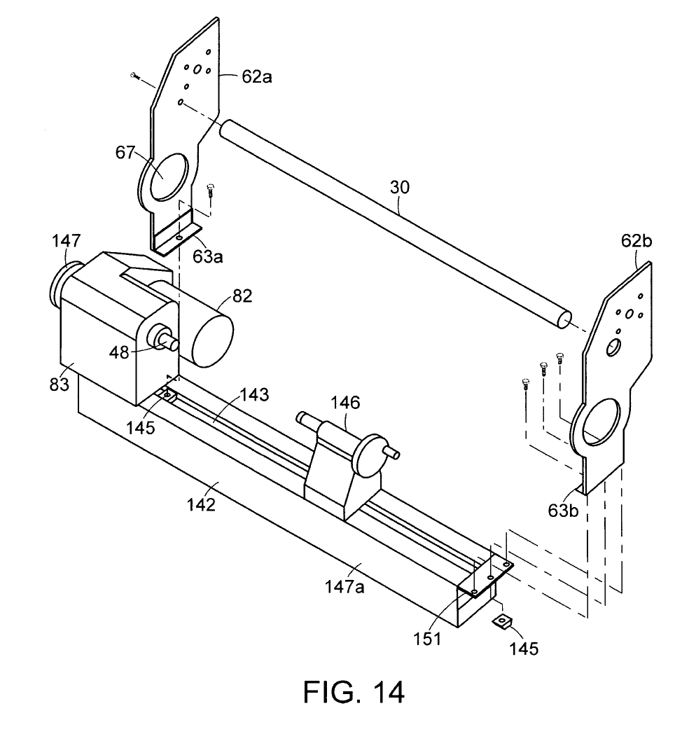

Referring to FIGS. 12-14, in another embodiment, lathe apparatus 140 can include an existing lathe 142 having drive center 48 that is driven by drive system 147 with a motor 82 (FIG. 14), and a tail center 49 on a tail stock assembly 146 that is adjustably positionable on a lathe bed 142a. The lathe apparatus 140 can include a lathe apparatus retrofit or assembly 149 that is mounted to the lathe bed 142a. The lathe apparatus assembly 149 can include end frame members 62a and 62b having mounting portions or brackets 63a and 63b for mounting to the lathe bed 142a. End frame member 62a can be mounted to the lathe bed 142a next to the housing 83 by securing bracket 63a to a nut 145 within bed slot 143 with a fastener such as a screw or bolt. (FIG. 14). The end frame member 62a can have a hole 67 through which the drive center 48 can extend. The end frame member 62b can be mounted to the lathe bed 142a at the far end by securing bracket 63b to a bracket 151 fastened to the end of the lathe bed 142a with fasteners such as screws or bolts. If desired, one or more nuts 145 can be also employed. The support rail 30, pattern holder 150 and carriage lead screw 42 can be mounted to and extend between the end frame members 62a and 62b. The pattern holder 150 can provide additional support and rigidity. The carriage lead screw 42 can be rotatably driven by a carriage drive system 152 having a drive motor 152a mounted to end frame member 62a. The drive system 152 can be controlled by controls 154 which can also be mounted to end frame member 62a. The controls 154 can include an on-off switch 154a and a speed control knob 154b. The pattern holder 150 can have securement portions 148a and 148b for securing the pattern 26 in position. The pattern holder 150 can secure a flat pattern 26 as shown, or it desired, can hold turned work pieces as patterns.

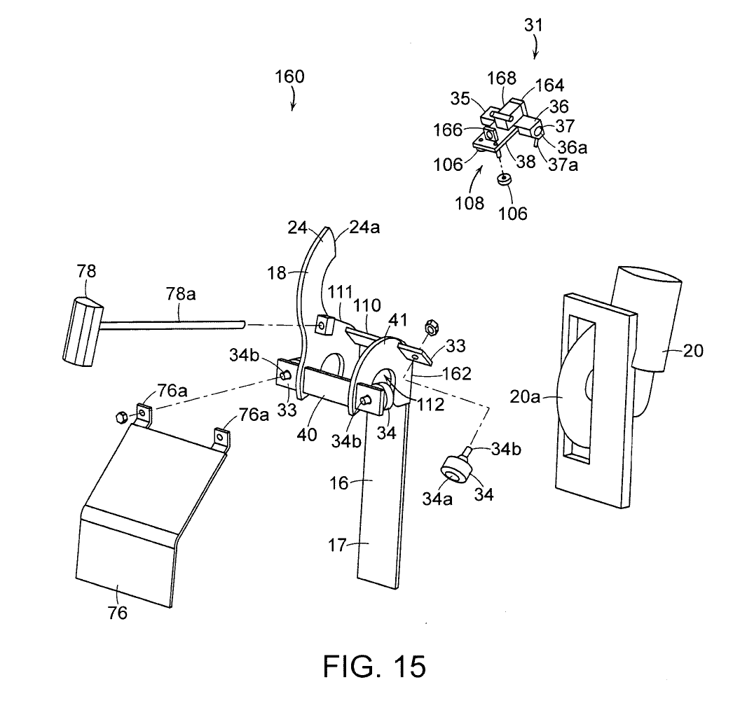

Referring to FIG. 15, carriage assembly 160 can have a carriage 162 which differs from carriage 14 in that carriage 162 has spaced flanges 111 and 41 that are connected together by two members or bars 110. The flanges 111 and 41 can include openings 112 for the support rail 30, and have mounts 33 for the roller bearing assemblies 34 that extend from the outer faces. Flange 41 can engage the space or gap 108 between rollers 106 of the drive nut assembly 31 to form joint 40. The pattern follower 24 can extend from flange 111 at the end of a curved follower arm 18 and have a curved contact surface where the contact point 24a is located. The cutting tool or saw arm 16 can be a rectangular member or piece extending downwardly from carriage 162 and can form a flat surface for the cutting tool or saw mount 17. The drive nut assembly 31 can include mounts 164 and 166 between which the spring 35 for spring loading the thread engaging forms 36a is extended. The spring 35 can have a cover 168. The components mounted to and between the end frame members 62a and 62b including the carriage assembly 160 can be considered a lathe apparatus retrofit assembly 149 that can be added to an existing lathe 142. The carriage assembly 160 can be provided with or without a rotary saw 20.

While this invention has been particularly shown and described with references to example embodiments thereof, it will be understood by those skilled in the art that various changes in form and details may be made therein without departing from the scope of the invention encompassed by the appended claims.

For example, various features of the embodiments shown and described can be combined or omitted. Embodiments of the present invention can employ stationary cutting tools instead of a rotary saw. Other embodiments do not have to include the copying features. The relative lengths of the arms 16 and 18 can be varied to change the pattern contour to work piece contour ratio. Although the bearing arrangement 32 has been described to provide both sliding and pivoting with bearing assemblies 34, in other embodiments, the bearing arrangement can have one bearing assembly for providing sliding, and a second bearing assembly for providing pivoting. Although an embodiment of joint 40 is formed by trapping or capturing a drive protrusion such as a curved flange 41 between rollers 106 to form a rolling joint, in other embodiments, the drive protrusion can be trapped or captured in a gap or space between stationary surfaces to form a sliding joint. Alternatively, the stationary surfaces can include spherical bearings which contact the drive protrusion. Furthermore, the carriage 14 can have a gap for accepting a drive protrusion extending from the drive nut assembly 31. Also, the joint 40 can be formed by a linkage, for example, a scissoring linkage. The drive screw 42 can be replaced by other suitable linear drive mechanisms, such as a electronically operated or fluid driven linear actuator.

What is claimed is:

1. A copying lathe apparatus comprising:
an elongate support rail;
a rotatable elongate drive screw positioned parallel to the support rail; and
a carriage assembly comprising:
a carriage member slidably mounted along and pivotably mounted about the support rail, the carriage member having a follower for contacting a pattern and a cutting tool mount for supporting a cutting tool capable of cutting a work piece, the follower and cutting tool mount each extending radially outward relative to the support rail, the follower capable of contacting the pattern and pivoting while the carriage member slides on the support rail and causing corresponding pivoting movement of the carriage member and cutting tool mount about the support rail so that the cutting tool is capable of cutting the work piece in a manner corresponding to the pattern, and
a drive member mounted to and driven by the drive screw, rotation of the drive screw for longitudinally moving the drive member and carriage member along the support rail, the drive member being connected to the carriage member by a joint that allows movement of the carriage member relative to the drive member to allow pivoting of the carriage member about the support rail.

2. The lathe apparatus of claim 1 further comprising a cutting tool mounted to the cutting tool mount, the cutting tool being a rotary saw having a rotary saw blade.

3. The lathe apparatus of claim 2 further comprising:
a work piece securement arrangement for supporting the work piece; and
a work piece drive system for rotating the work piece in a direction opposite to rotation of the rotary saw blade.

4. The lathe apparatus of claim 3 in which the rotary saw has a saw blade that is capably of being skewed at an angle relative to the work piece.

5. The lathe apparatus of claim 1 in which the drive member has thread engaging portions which are spring loaded.

6. The lathe apparatus of claim 1 in which the joint is formed by a drive protrusion on the carriage member extending into a gap on the drive member.

7. The lathe apparatus of claim 6 in which the drive protrusion has a curved periphery to allow movement within said gap when the carriage member pivots.

8. The lathe apparatus of claim 7 in which the gap is formed between outer surfaces of two spaced apart rollers.

9. The lathe apparatus of claim 1 in which the support rail has a circular periphery.

10. The lathe apparatus of claim 9 in which the carriage member includes a set of rollers which are positioned to provide rolling along the support rail in the longitudinal direction and pivoting about the support rail.

11. The lathe apparatus of claim 1 further comprising a pattern holder for holding the pattern.

12. The lathe apparatus of claim 11 in which the support rail, drive screw and pattern holder are mounted between end frame members.

13. The lathe apparatus of claim 12 in which the lathe apparatus is securable to an existing lathe.

14. A copying lathe attachment comprising:
end frame members for attachment to a lathe;
an elongate support rail extending between the end frame members;
a rotatable elongate drive screw positioned parallel to the support rail and extending between the end frame members; and
a pattern holder for holding a pattern extending between the end frame members;
a carriage assembly comprising:
a carriage member slidably mounted along and pivotably mounted about the support rail, the carriage member having a follower for contacting the pattern and a cutting tool mount for supporting a cutting tool capable of cutting a work piece, the follower and cutting tool mount each extending radially outward relative to the support rail, the follower capable of contacting the pattern and pivoting while the carriage member slides on the support rail and causing corresponding pivoting movement of the carriage member and cutting tool mount about the support rail so that the cutting tool is capable of cutting the work piece in a manner corresponding to the pattern, and
a drive member mounted to and driven by the drive screw, rotation of the drive screw for longitudinally moving the drive member and carriage member along the support rail, the drive member being connected to the carriage member by a joint that allows movement of the carriage member relative to the drive member to allow pivoting of the carriage member about the support rail.

15. The lathe attachment of claim 14 further comprising a cutting tool mounted to the cutting tool mount comprising a rotary saw having a rotary saw blade.

16. The lathe attachment of claim 14 in which the drive member has thread engaging portions which are spring loaded.

17. The lathe attachment of claim 14 in which the joint is formed by a drive protrusion on the carriage member extending into a gap on the drive member formed between outer surfaces of two spaced apart rollers, the drive protrusion having a curved periphery to allow movement within said gap when the carriage member pivots.

18. The lathe attachment of claim 14 in which the support rail has a circular periphery and the carriage member includes a set of rollers which are positioned to provide rolling along the support rail in the longitudinal direction and pivoting about the support rail.

19. A method of copying a pattern onto a work piece with a copying lathe apparatus comprising:
providing an elongate support rail;
positioning a rotatable elongate drive screw parallel to the support rail;
slidably and pivotably mounting a carriage member of a carriage assembly about the support rail, the carriage member having a follower for contacting the pattern and a cutting tool for cutting the work piece, the follower and cutting tool each extending radially outward relative to the support rail; and
driving a drive member with the drive screw, rotation of the drive screw for longitudinally moving the drive member and carriage member along the support rail, the drive member being connected to the carriage member by a joint that allows movement of the carriage member relative to the drive member to allow pivoting of the carriage member about the support rail, the follower contacting the pattern and pivoting while the carriage member slides on the support rail and causing corresponding pivoting movement of the carriage member and cutting tool about the support rail for cutting the work piece in a manner corresponding to the pattern.

20. The method of claim 19 further comprising using a rotary saw having a rotary saw blade as the cutting tool.

21. The method of claim 20 further comprising:
supporting the work piece with a work piece securement arrangement; and
rotating the work piece in a direction opposite to rotation of the rotary saw with a work piece drive system.

22. The method of claim 21 in further comprising skewing the rotary saw blade at an angle relative to the work piece.

23. The method of claim 19 in which the drive member has thread engaging portions, the method further comprising spring loading the thread engaging portions.

24. The method of claim 19 further comprising forming the joint by extending a drive protrusion on the carriage member into a gap on the drive member.

25. The method of claim 24 further comprising providing the drive protrusion with a curved periphery to allow movement within said gap when the carriage member pivots.

26. The method of claim 25 further comprising forming the gap between outer surfaces of two spaced apart rollers.

27. The method of claim 19 further comprising providing the support rail with a circular periphery.

28. The method of claim 27 further comprising positioning a set of rollers on the carriage member to provide rolling along the support rail in the longitudinal direction and pivoting about the support rail.

29. The method of claim 19 further comprising for holding the pattern with a pattern holder.

30. The method of claim 29 further comprising mounting the support rail, drive screw and pattern holder between end frame members.

31. The method of claim 30 further comprising securing the lathe apparatus to an existing lathe.
